(19) United States
(12) Patent Application Publication
(10) Pub. No.: US 2002/0116670 A1
(43) Pub. Date: Aug. 22, 2002

(54) Failure supervising method and apparatus

(76) Inventors: Satoshi Oshima, Tachikawa (JP); Toshiaki Arai, Machida (JP); Masahide Sato, Kawasaki (JP); Hiroki Ukai, Kasugai (JP)

Correspondence Address: MCDERMOTT, WILL & EMERY, 600 13th Street, N.W., Washington, DC, 20005-3096, US

(21) Appl. No.: 09/978,183

(22) Filed: Oct. 17, 2001

(30) Foreign Application Priority Data
Feb. 22, 2001 (JP) 2001-045950

(51) Int. Cl. G06F 11/30

(52) U.S. Cl. 714/55

(57) ABSTRACT

A failure supervising method and apparatus are disclosed. Simply with a WDT by which a system is interrupted after the WDT goes time out, the system would stop in a serious case where the failure cannot be recovered from by the interruption alone. A plurality of stages of WDTs are operatively interlocked, and the interlocked WDTs interrupt the system strongly progressively in each of the stages. A small failure recoverable by an interrupt is recovered by an interrupt, a middle failure not recoverable by other than a non-maskable interrupt is recovered by a non-maskable interrupt, and a serious failure not recoverable by other than reactivation is recovered by resetting the system.

### BACKGROUND OF THE INVENTION

The present invention relates to the failure supervision of a system or in particular to the failure supervision of a computer system by interrupt from an extended device.

A method of supervising the failure of a system using what is called a watch dog timer (WDT) is available. According to the WDT method, the elapsed time is measured by the timer, and the system is reactivated upon the lapse of a predetermined length of time. As long as the system is operating normally, the system is prevented from being reactivated by resetting the timer at regular time intervals. In the case where the system runs away to such an extent that the WDT cannot be reset, the timer goes time out and reactivates the whole system. This procedure makes it possible to continue the system operation.

In a technique related to WDT, after the timer goes time out, the flag is set or a normal interrupt or a non-maskable interrupt (NMI) is initiated.

The system manager is desirous of recovering from a system failure, if any develops, without stopping the service as far as possible. Even in the case where the reactivation due to the stop caused by the failure is unavoidable, it is the desire of the system manager to prevent the recurrence of the failure by collecting as much information on the failure as possible.

A simple WDT, however, only reactivates the system which may have run away. Depending on the type of the failure, the system may be interrupted to recover from the failure or the recurrence of the failure can be prevented by collecting the information on the failure. With a WDT which only interrupts the system after the WDT goes time out, the system may stop in a serious case where the recovery from the failure is impossible.

Further, the conventional WDT has provided a method of resetting the timer by setting the reset data in a timer reset port or by outputting a WDT reset instruction to the timer reset port. The conventional method, however, cannot be implemented in the case where a system has a plurality of processors and it is desired to detect a failure of at least one of the processors.

A method of recovery from a failure is an interrupt, the NMI (Non Maskable Interrupt) and the system reset, which have both advantages and disadvantages as described below.

Specifically, in the recovery from a failure by an interrupt, the failure can be recovered from without reactivating the system by resetting the system state not recorded in a nonvolatile memory, the recovery from the failure cannot be realized in the case where the interrupt is prohibited or the system cannot be operated even with an interrupt receivable.

The recovery from a failure by NMI destroys the critical region and makes it difficult to continue the system operation. Further, although the failure can be recovered from without reactivating the system by resetting the system state not recorded in a nonvolatile memory, the possibility of invasion of the critical region cannot be denied and therefore the system is required to be reactivated to stabilize the system.

The recovery from a failure by resetting the system can meet all the system states. Nevertheless, since all the information not stored in the nonvolatile memory are reset, the system condition at the time of the failure is unknown to the manager, thereby leading to the problem that information is not sufficiently available for taking a measure to prevent the recurrence of the failure.

### SUMMARY OF THE INVENTION

The object of the present invention is to provide a failure supervising method and apparatus in which a plurality of stages of WDT output a stronger interrupt in the system at a higher stage. Specifically, according to the present invention, the type (degree) of the interrupt is changed in accordance with the degree of the failure, and the recovery from the failure is performed in accordance with the interrupt.

In the case where the timer in the first stage goes time out, for example, a system is interrupted while at the same time starting the WDT in the second stage. The system, if it can be released from the failure by the interrupt in the first stage, takes such an action as to reset or stop the WDT. In the case where the system cannot be released out of the failure by the interrupt in the first stage, on the other hand, the WDT in the second stage goes time out and the system outputs an interrupt or a non-maskable interrupt. In the case where the system cannot be released from the failure even by this interrupt, the WDT in the third stage is activated. In the case where the the WDT in the third stage goes time out, the system is reactivated by being reset.

Means for resetting the WDT is provided by a plurality of WDT reset ports. This mechanism can detect the failure of one of a plurality of processors operating in parallel in a multiprocessor system.

### BRIEF DESCRIPTION OF THE DRAWINGS

FIG. 1 is a flowchart showing the operation of a failure supervising apparatus and a block diagram showing a configuration of the ports for controlling the failure supervising apparatus according to an embodiment of the present invention.

FIG. 2 is a block diagram showing an internal configuration of a nonvolatile memory in FIG. 1.

FIG. 3 is a block diagram showing the relation between the OS (Operating System) of a computer and a failure supervising apparatus according to an embodiment of the invention.

FIG. 4 is a block diagram showing the relation between a computer having a plurality of processors and a failure supervising apparatus according to an embodiment of the invention.

### DETAILED DESCRIPTION OF THE EMBODIMENTS

The present invention will be described in detail below with reference to the drawings.

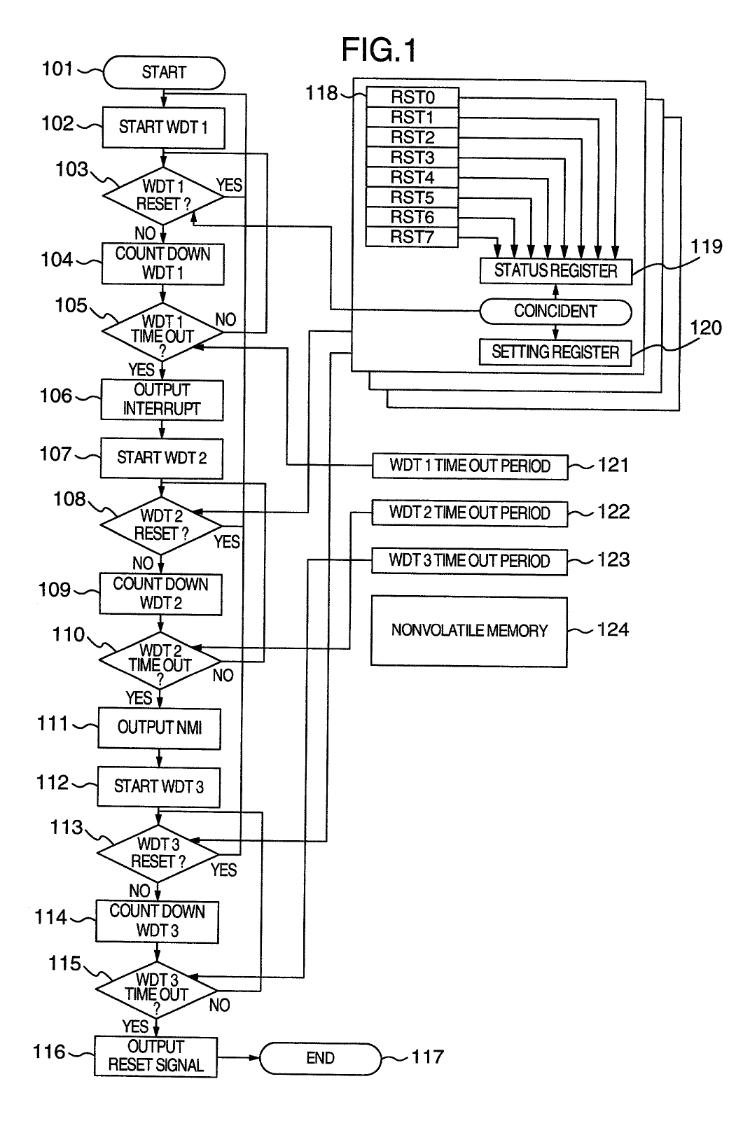

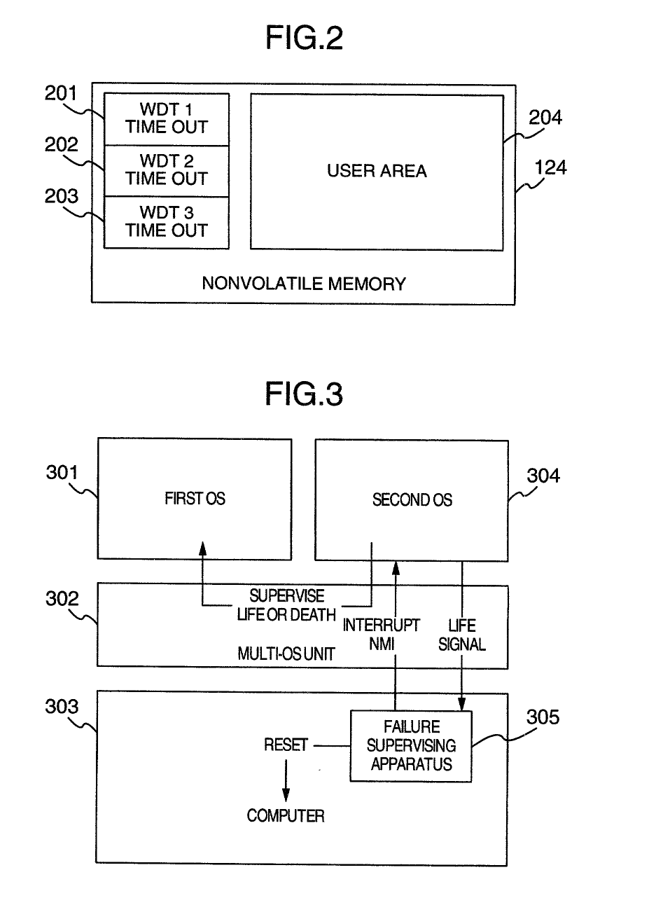

FIG. 1 is a flowchart showing the operation of a failure supervising apparatus and a block diagram showing a configuration of the registers for controlling the failure supervising apparatus according to an embodiment of the invention. FIG. 2 shows the internal configuration of a nonvolatile memory 124. Steps 101 to 117 in FIG. 1 represent the operation of the watch dog timers WDT in three stages.

In the failure supervising apparatus, the operation starts with step 101, followed by the activation of the WDT 1 (step 102). Whether the WDT 1 is reset or not is checked (step 103). The method of resetting the WDT will be described in detail later. Unless the WDT 1 is reset, the process is returned to step 102 for reactivating the WDT 1. If the WDT 1 is not reset again, the count on the WDT 1 is advanced (step 104) to determine whether the WDT 1 has gone time out or not (step 105). The time-out period 121 of the WDT 1 is used as a set value for this determination. Unless the WDT 1 has gone time out, the process is returned to step 103 for determining whether the WDT 1 has been reset or not. In the case where the WDT 1 has gone time out, on the other hand, an interrupt signal is output to the system. At the same time, information indicating that the interrupt signal is output is applied to a WDT 1 time-out period 201 in the nonvolatile memory 124 thereby to activate the WDT 2 (step 107).

The WDT 2, like the WDT 1, is checked whether it is reset or not (step 108), and the WDT 2 is counted down (step 109). It is then determined whether the WDT 2 has gone time out or not by using the WDT 2 time-out period 122 (step 110). Once the WDT 2 is reset, the process returns to step 102 for activating the WDT 1. In the case where the WDT 2 has gone time out, a non-maskable interrupt (NMI) signal is output and the information indicating that the NMI signal is output is applied to the WDT 2 time-out 202 of the nonvolatile memory 124 (step 111). Then, the WDT 3 is activated (step 112).

The WDT 3 operates the same way as the WDTs 1 and 2. In the case where the WDT 3 goes time out, the information indicating that a reset signal is output is applied to the WDT 3 time out 203 of the nonvolatile memory 124 thereby to output a system reset signal. As a result, the whole system is reactivated.

Now, the method of resetting the WDTs 1, 2 and 3 will be explained. A WDT reset port unit 118 includes eight ports as shown in FIG. 1. The information such as the status is written at regular time intervals in each port of the reset port unit 118 by a supervisee (such as the OS described later). Each port has bits corresponding to a status register 119. Once data are set in a given port, the corresponding bits of the status register 119 are set. The failure supervising apparatus compares the status register 119 with a setting register 120 which is preset, and in the case of coincidence in value, clears the status register 119 and resets the WDT. This operation is shared by the WDTs 1, 2 and 3.

A user area 204 is open for use by the host software of the computer system.

FIG. 3 shows a configuration including the failure supervising apparatus 305 shown in FIG. 1, in which two operating systems are activated on a single computer 303 having one processor by as a multi-OS unit as disclosed in JP-A-11-149385. A first OS 301 performs the ordinary job, and a job application program operates on this OS 301. A second OS 304, on the other hand, supervises the life and death of the first OS 301 through the multi-OS unit 302. In the case where the second OS 304 detects that the first OS 301 has developed a failure, the multi-OS unit 302 can function to acquire the status of the first OS or reactivate the first OS alone thereby to recover from the failure. Further, the second OS 304 includes a device driver for controlling the failure supervising apparatus 305 and, at the time of activation, sets the WDT time-out periods 121, 122, 123 of the failure supervising apparatus 305. Furthermore, the number of bits corresponding to the RST O of the reset port unit 118 are set in the setting register 120. The second OS issues to the apparatus 305 a life signal indicating that it is alive by outputting the information to the RST O of the reset port unit 118 at regular time intervals within the time-out period of the WDT 1. In the case where the second OS comes to stop due to the failure of the first or second OS, the life signal output, i.e. the signal output to the RST O of the reset port unit 118 also dies out, so that the WDT 1 and even the WDT 2 go time out and an interrupt or NMI is output to the second OS 304 through the multi-OS unit 302.

Normally, the second OS 304 can recover from the failure by the interrupt or NMI. The device driver of the second OS 304 for the failure supervising apparatus 305 deactivates the WDTs and starts collecting the failure information. First, the second OS can grasp the degree of the failure by accessing the WDT 1 time out 201 or the WDT 2 time out 202 in the nonvolatile memory 124 of the failure supervising apparatus 305 shown in FIG. 2. In the case where the output is an interrupt, the failure, if not caused by the second OS 304, can be recovered by reactivating only the first OS 301 after acquiring the failure information of the first OS 301 in the second OS 304.

In the case where the failure is caused by the second OS 304 or the output is not an interrupt but a NMI signal, on the other hand, the critical region of the first OS 301, the second OS 304 or the multi-OS unit 302 is possibly invaded. Therefore, the second OS 304 collects the failure information from the first OS 301, after recording the particular information in the user area 204 of the nonvolatile memory 124, issues a system reset signal and thus reactivates the system. After reactivation, the system manager acquires the failure information remaining in the user area 204 and thus can find a clue to a countermeasure to be taken for preventing the recurrence of the failure.

Even in the case where the second OS 304 develops a failure irreparable by the interrupt or NMI generated from the failure supervising apparatus 305, the system can be prevented at least from going down by resetting and reactivating the system after the WDT 3 goes time out.

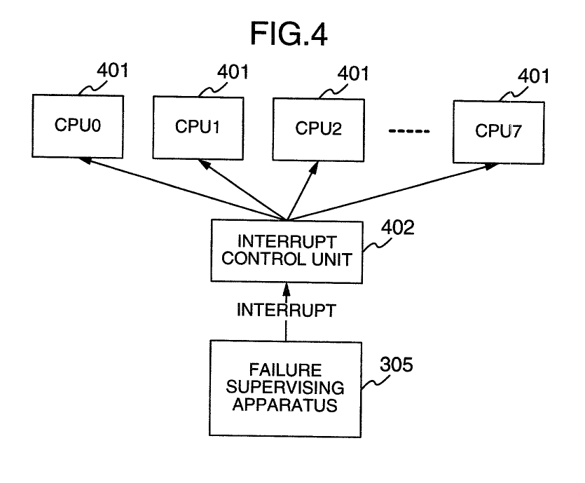

FIG. 4 shows an example of a configuration in which the failure supervising apparatus 305 shown in FIG. 1 is included in a computer having eight processors 401 (hereinafter referred to as the CPUs) and an interrupt control unit 402. In this computer, the interrupt control unit can determine to which processor the interrupt is to be transmitted or whether it is transmitted as a maskable interrupt or not. Each OS on the computer has a device driver for the failure supervising apparatus. The device driver sets all the bits of the setting register 120 in the failure supervising apparatus 305 thereby to validate all the ports of the reset port unit 118. Each CPU outputs information to the corresponding one of the reset ports RST 0 to RST 7 (from CPU 0 to RST 0, and from CPU 1 to RST 1, for example) in the failure supervising apparatus and thus notifies the failure supervising apparatus that the particular CPU is in normal operation.

Assume that at least one of the processors CPU 0 to CPU 7 develops a failure. Since all the reset ports RST 0 to RST 7 are not rewritten, the status register 119 and the setting register 120 fail to coincide with each other. Thus, the WDTs are not reset and go time out.

Once the WDTs go time out, the failure supervising apparatus 305 interrupts the operation of the processors CPU 0 to CPU 7 through the interrupt control unit 402. The interrupt control unit 402 can selectively determine which processor is to be interrupted and whether the interrupt can be masked or not.

As described above, the failure supervising apparatus according to this invention comprises the step of operatively interlocking a plurality of stages of WDTs and the step of causing the operatively interlocked WDTs to interrupt the system strongly in stages, wherein a failure recoverable by an interrupt can be recovered by an interrupt, a failure recoverable only by a non-maskable interrupt can be recovered by a non-maskable interrupt, and a failure recoverable only by a system reset can be recovered by a system reset operation. Also, the provision of the WDT reset port unit having a plurality of ports which can determine the validity or invalidity by setting makes it possible to supervise even the failure of a computer having a plurality of processors operating in parallel.

1. A method of supervising a failure of a system using a timer, comprising the steps of:
(a) activating said timer and determining whether said timer is reset or not;
(b) counting down said timer if not reset;
(c) determining whether said timer has gone time out at a predetermined time;
(d) generating a signal for recovery from the failure in the case where said timer has gone time out; and
(e) repetitively executing said steps (a) to (d) for the next timer in the case where the failure cannot be recovered from.

2. A failure supervising method according to claim 1, wherein in accordance with the signal generated in step (d), the step of setting a flag, the step of outputting an interrupt signal, the step of outputting a non-maskable interrupt and the step of outputting a system reset signal are sequentially executed, thereby recovering from the failure in accordance with the degree of the failure progressively each time said step (e) is executed.

3. A failure supervising method according to claim 1, wherein a plurality of conditions are set for resetting said timer, and the timer reset operation and the corresponding one of said conditions are combined each time said step (e) is executed.

4. A failure supervising method according to claim 1, wherein the step executed in accordance with said signal generated in said step (d) is recorded.

5. An apparatus for supervising a failure of a system using a timer, comprising:
(a) means for activating said timer and determining whether said timer is reset or not;
(b) means for counting down said timer if not reset;
(c) means for determining whether said timer has gone time out at a predetermined time;
(d) means for generating a signal for recovery from the failure in the case where said timer has gone time out; and
(e) means for repetitively activating said means (a) to (d) for the next timer in the case where the failure cannot be recovered from.

6. A failure supervising apparatus according to claim 5,
wherein in accordance with the signal generated from said signal generating means, the step of setting a flag, the step of outputting an interrupt signal, the step of outputting a non-maskable interrupt and the step of outputting a system reset signal are sequentially executed, thereby recovering from the failure in accordance with the degree of the failure each time said repetitively activating means (e) is activated.

7. A failure supervising apparatus according to claim 5,
wherein a plurality of conditions are set for resetting said timer, and the timer reset operation and the corresponding one of said conditions are combined each time said repetitively activating means is activated.

8. A failure supervising apparatus according to claim 5,
wherein said signal generating means includes means for recording the step executed in accordance with said generated signal.

9. A method of supervising a failure of a system using a timer, comprising the steps of:
(a) counting down said timer in the case where the activated timer is not reset;
(b) executing the steps for recovering from the failure in the case where said timer goes out at a predetermined time; and
(c) in the case where said system fails to recover from the failure, repeatedly executing the steps (a) and (b) for the next timer thereby to recover from the failure in accordance with the degree of the failure progressively in each stage.
